(19) United States
(12) Patent Application Publication
(10) Pub. No.: US 2006/0104449 A1
(43) Pub. Date: May 18, 2006

(54) Record carrier with distributed decryption information

(76) Inventors: Antonius H.M. Akkermans, Veldhoven (NL); Franciscus L.A.J. Kamperman, Geldrop (NL); Antonius A.M. Staring, Eindhoven (NL); Marten E. Van Dijk, Cambridge, MA (US); Pim T. Tuyls, Mol (BE)

Correspondence Address: PHILIPS INTELLECTUAL PROPERTY & STANDARDS, P.O. BOX 3001, BRIARCLIFF MANOR, NY, 10510, US

(21) Appl. No.: 10/519,068

(22) PCT Filed: Jun. 26, 2003
(86) PCT No.: PCT/IB03/02504

§ 371 Date: Oct. 31, 2005

(30) Foreign Application Priority Data
Jul. 5, 2002 (EP) 02015057.9

(51) Int. Cl. H04L 9/00

(52) U.S. Cl. 380/277

(57) ABSTRACT

The invention relates to a system for improved copy protection comprising a record carrier like a CD-RW+ or a DVD storing copy-protected information and a device for reading from and/or writing to the record carrier. For that the record carrier (1) has a first area (3) storing information (data), which is at least partly stored in encrypted form (EAK(data)), this part being called an asset (EAK(data)), and which includes a first part of decryption information (HCK, EDNK(HCK)), and the record carrier (1) further has a second area (4) storing a second part of decryption information (UCID), wherein both the first (HCK) and second (UCID) parts of decryption information serve in decrypting an asset (EAK(data)). Such distribution of decryption information over at least two areas of the record carrier may further be combined with additional safety mechanisms as e.g. hidden channels, encrypted keys, counter mechanisms, and revocation lists.

This invention relates to a record carrier storing copy-protected information. Examples of such record carriers are mainly Audio CDs, CD-ROMs, CD-Rs, CD-RWs, DVDs etc., but the invention is equally applicable to other record carriers as well, as e.g. magnetic tapes, diskettes, and hard disks.

Record carriers such as CDs or DVDs are nowadays a mass product used e.g. for distributing audio and video content for entertainment purposes and to supply software and computer games. Moreover, certain kinds of these media such as the CD-R and the CD-RW+ are once or several times recordable e.g. by using a CD burner. They are therefore also usable for short-term backup as well as for long-term archiving purposes. Moreover, the increasing storage capacities of these devices extend their applicability even further.

On the other hand, the existence of these easy to handle and durable recordable media in connection with the digital representation of the media contents opened an easy way of taking one-to-one copies of copyrighted CDs, which nowadays presents a major commercial problem for the content industries.

Accordingly, several methods for copy protection of such record carriers have been proposed in the state of the art. Typically, there is a trade-off between the effort spend for copy protection, measured e.g. in the amount of computing power and memory required or public infrastructure to be installed, and the level of protection reached. Therefore, while there exist methods like e.g. asymmetric keying allowing a protection level currently being regarded as safe, most methods being actually used with CDs do not completely prevent copying but just make it more difficult.

For copy protection, many methods propose to store the content to be protected in an encrypted form on the record carrier. Then, in order to utilize the content, e.g. to play a song from an audio CD, a corresponding decryption information is needed. This decryption information may be stored on the record carrier together with the content or on a separate medium. Storing the decryption information on the record carrier together with the content has e.g. the drawback that a one-to-one copy is indistinguishable from the original and, thus, constitutes an easy way to break the copy protection. Storing the decryption information on a separate medium can prevent such easy copying by choosing a more difficult to copy medium as e.g. a smart card. On the other hand, using a separate medium has at least the drawback that the record carrier can only be used in conjunction with the separate medium and, thus, requires from the user a careful joint usage and storage of both the record carrier and the separate medium.

U.S. Pat. No. 6,044,046 A therefore proposes to use as a separate medium a chip being physically integrated within the record carrier. This renders the record carrier with built-in chip as easy to handle as a record carrier itself. Furthermore, U.S. Pat. No. 6,044,046 A discloses the communication interfaces of the chip and of a corresponding device for reading and/or writing the record carrier with built-in chip. In particular, a solution is described for allowing the reading and/or writing device simultaneous access to the record carrier and the built-in chip. For the full description of these and related issues the contents of U.S. Pat. No. 6,044,046 A is herewith incorporated into this application by reference.

While being an elegant solution, also the copy-protection scheme of U.S. Pat. No. 6,044,046 A has its drawbacks. Consider e.g. the following situation of content distribution over the Internet, first examples of which have already been introduced. A user might buy and download content as e.g. a video via the Internet in order to store it on a record carrier. While, of course, the internet is an insecure channel, there are methods known as e.g. the already mentioned asymmetric keying for conducting secure communications over insecure links, turning such insecure channels into so-called secure authenticated channels. For a more explicit description of the issues relating to secure communications over insecure links the contents of U.S. Pat. No. 5,949,877 A is herewith incorporated into this application by reference.

Thus, assuming that also the hardware and applications being installed at the user's premises and participating in the process of downloading the content have a high enough level of copy protection the content can be securely written e.g. to a record carrier with built-in chip at the user's premises. But in order to do so the decrypting information for the bought content has to be written to the chip at the user's premises, i.e., this part of the chip's memory has to be programmable. Accordingly, recordable record carriers with in such a way programmable built-in chips have to be commercially available.

As a consequence, if the decryption information of a specific content once is tapped, e.g. by tapping the channel between the device writing to the chip and the chip, which might e.g. be realized by optical coupling elements, then the decryption information might be stored e.g. on a hard disk. Subsequently, the decryption information then might be published on the Internet and/or counterfeit chips might be programmed with it. Doing a one-to-one copy of the contents of the record carrier on record carriers with such counterfeit built-in chips breaks the security mechanism.

Therefore, it is an object of this invention to provide a record carrier and a corresponding device for reading from it and/or writing to it that provides a higher level of protection than the known record carriers with built-in chips without significantly increasing the complexity of producing and operating such record carriers and devices.

These objects are accomplished by
a record carrier having a first area storing information, which is at least partly stored in encrypted form, such a part being called an asset, and which includes a first part of decryption information, and the record carrier further having a second area storing a second part of decryption information, wherein both the first and second parts of decryption information serve in decrypting an asset, this decryption being called asset decryption,
and by
a device for reading from and/or writing to a record carrier as claimed in claim 1, wherein the device is designed
   for reading and/or writing the first part of decryption information, and
   for reading and/or writing the second part of decryption information, and
   for reading and/or writing an asset, and,
   optionally, for obtaining complete decryption information from both the first and second parts of decryption information, and,
   optionally, for decrypting and/or encrypting the asset with the complete decryption information.

Whereas a device for reading from and/or writing to an inventive record carrier may well be designed to take over the tasks of obtaining complete decryption information and/or decrypting and/or encrypting an asset these tasks may also be transferred to another device being coupled to the reading and/or writing device. E.g., a processor of a PC containing such a reading and/or writing device as a peripheral device may take over one or both of these tasks. On the other hand, in a home entertainment system as e.g. an audio CD or video DVD player the integration of these tasks in the reading and/or writing device is preferable.

Together, the record carrier and the device for reading from and/or writing to it form a system for supporting copy protection according to the invention. Moreover, the invention provides a method for reading copy-protected information from and/or writing copy-protected information to an inventive record carrier.

Thus, the higher level of protection stems from distributing the decryption information on at least two areas of a record carrier instead of concentrating it e.g. on the built-in chip alone. Distributing the decryption information on the first and second areas thus complicates an illegal copying of the record carrier.

In this construction the first area typically serves for storing the payload information, e.g. the songs and/or videos and/or the computer games a user wants to purchase. The second area might also be a pure storage area, but in a preferred embodiment comprises a chip as in the record carrier with built-in chip disclosed in U.S. Pat. No. 6,044,046 A. The stores on the first and second areas might be of the same physical nature, e.g. both being a pattern of pits and lands to be read via a laser, but preferably they utilize different physical implementations, e.g. pits and lands for the first area and some simple circuitry coupled with an induction coil for the second area. This gives the advantage of different physical channels, e.g. an optical and a radio frequency one, that can be accessed in parallel. In the same manner, in some embodiments it will be advantageous to physically clearly separate the first and second areas, e.g. implementing the first area as the conventional spiral pattern of a CD and positioning the second area between the center hole and the inner data track of the CD. This avoids mutual interference of the communication channels between the two areas of the record carrier and a reading and/or writing device.

Embodying an inventive record carrier and its reading and/or writing device in a manner that the record carrier's first and second areas can be read and/or written in parallel offers the advantage that the reading and/or writing device can handle the data on the two areas independently of each other, i.e. the two data streams can be processed without disturbing each other. This offers e.g. the possibility to continuously check, e.g. at regular or irregular intervals in time, the authenticity and/or integrity of the record carrier, thus further complicating the use of an illegal record carrier. E.g., if the reading and/or writing device reads the second part of decryption information, e.g. via a radio frequency channel, only once when the record carrier is inserted in the device a hacker may betray the device by supplying the decryption information using specialized hacked equipment. This kind of attack gets much more involved if the reading and/or writing device requests the second part of decryption information several times at e.g. irregular time intervals.

Using an inventive record carrier, the content distribution and copy-protection scheme can be structured in a way that at least part of the second part of decryption information on the second area of the record carrier need not be written at the user's premises while purchasing and downloading new content e.g. from the Internet. Accordingly, the user's equipment can be designed by industry in a way that it not able to make a complete one-one-copy of an inventive record carrier. Thus, the above-mentioned attack of tapping the decryption information and doing a one-to-one copy would not be possible with legal devices for writing record carriers, as e.g. a CD burner.

Choosing a non-re-writable or more difficult to re-write memory type for the parts of the second area that need not be re-written can further increase this level of protection. E.g., if the second area comprises a chip one may choose a ROM, a PROM, or a flash ROM. Then, one-to-one copying of the second area of the record carrier requires specialized equipment or may be even completely impossible.

The remaining claims and sub-claims disclose further advantageous embodiments of the invention.

Having the second part of decryption information comprising an identifier, and, in particular, an identifier being unique among all such identifiers, yields an especially high level of protection as even record carriers carrying the same payload can then be made different from each other. Thus, the invention also relates to the corresponding selection of an identifier, the construction of the second part of decryption information from the identifier, and the production of the record carrier with said second part of decryption information. Such construction may e.g. simply consist in equating the identifier with the second part of decryption information but may also first encrypt the identifier and/or enhance it with further data before using it as the second part of decryption information.

In preferred embodiments, symmetric methods using two or even three cryptographic keys are used for en- and decryption. As these methods are computationally more efficient than asymmetric ones processing time is saved and memory requirements are lower.

If an inventive record carrier is constructed by using a built-in chip, implementing active procedures on this chip further increases the level of protection. Examples for such procedures are a counter mechanism as well as an access checking procedure. For the latter, well-known password or PIN checking methods are known in the state of the art. To this end, the contents of EP 0 919 904 A2 are included in this application by reference. Thus, different parts of the record carrier may be protected by different passwords, allowing e.g. the use of the record carrier by different people and/or for different purposes and/or kinds of data being stored, e.g. entertainment data, business data, and account data.

The second area of an inventive record area, in particular, if it is realized as a built-in chip, further offers the advantageous possibility of storing account information on the usage of the record carrier or the data and/or programs stored on it, e.g. the scores obtained in playing a stored computer game. Moreover, other personalizing information on the way a user wants to handle the record carrier can be stored in the second area. These user-specific settings, possibly in connection with the above-mentioned password mechanism, can serve in selecting the data, which are accessible on the record carrier, and/or on the way such data are presented. E.g., a particular setting may determine which songs are played from an audio CD and in which sequence they are played. Thus, functionalities as e.g. Favorite Track Selection FTS and Parental Lock, currently being programmed into the player, will become available in the record carrier itself and, consequently, carry over to every appropriate player. Other examples for user-specific settings can be found in the personalization of web pages found on the Internet as e.g. in “My Yahoo!”, which analogously carry over to corresponding applications concerning data being stored on an inventive record carrier.

If the second part of decryption information comprises an identifier, and, in particular, a unique identifier, this identifier can be advantageously used for indexing illegal record carriers on a revocation list, sometimes also called a black list. Thus, if an illegal copy of an inventive record carrier appears on the market, the copy including a copy of the identifier, this identifier can be placed on a revocation list. One can then distribute such revocation lists to the reading and/or writing devices e.g. via legal record carriers or via the Internet while downloading legal content. Subsequently, these devices can refuse to play these illegal record carriers and/or can even block their services completely or for a certain time. For further details concerning the well-known procedure of employing such revocation lists of counterfeit media the contents of U.S. Pat. No. 6,028,936 are included in this application by reference.

Of course, as is obvious to one skilled in the art, one may combine the above-described measures for obtaining an even improved copy protection. E.g., one may combine symmetric encryption methods with a counter mechanism and a password checking, and enhance the record carrier's functionality by storing user-specific settings on the chip.

These and further aspects and advantages of the invention will be further illustrated by the embodiments and, in particular, by the description of the attached figures.

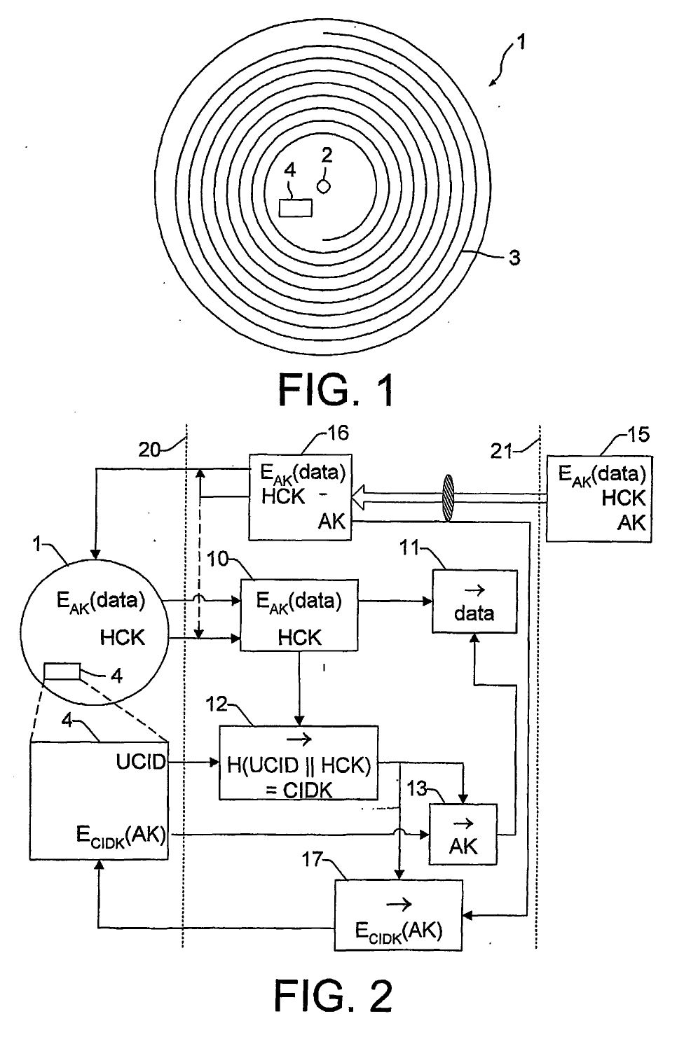

FIG. 1 shows diagrammatically an inventive record carrier.

FIG. 2 shows a block diagram of a first embodiment of the reading and writing of data on an inventive record carrier, this first embodiment employing a hidden channel between the first area of the record carrier and the reading device.

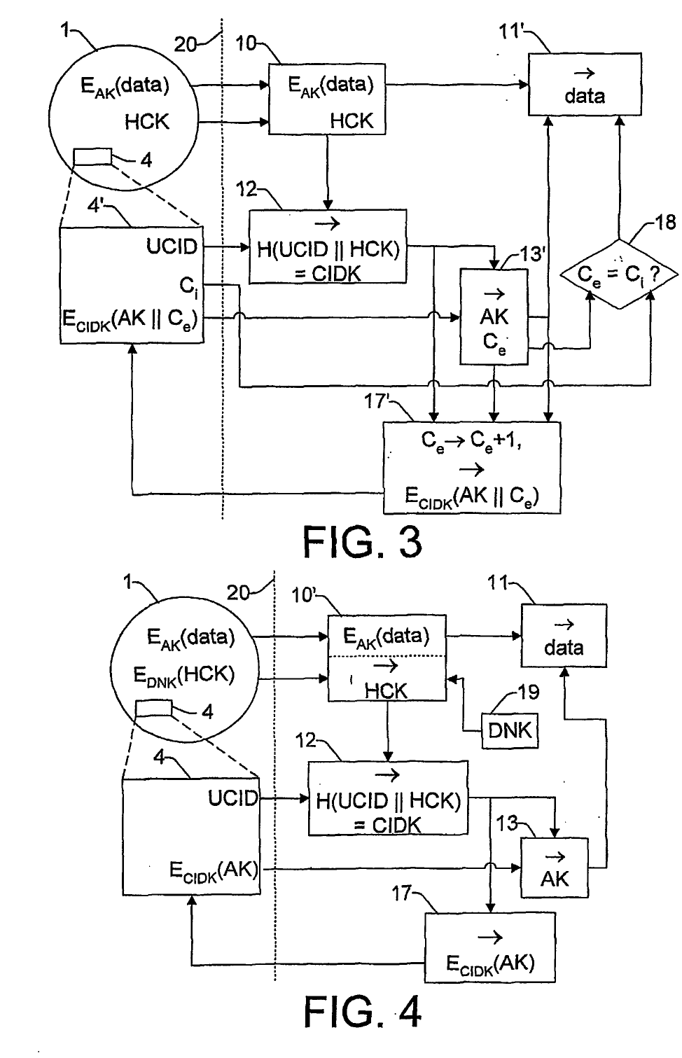

FIG. 3 shows a block diagram of a second embodiment of the reading and writing of data on an inventive record carrier, this second embodiment employing a counter mechanism.

FIG. 4 shows a block diagram of a third embodiment of the reading and writing of data on an inventive record carrier, this third embodiment employing an encrypted key on the first area of the record carrier.

FIG. 1 shows diagrammatically an inventive record carrier 1, which may comprise information, with a central aperture 2 and a track 3. The track 3 is arranged in a spiral or concentric pattern and comprises a first area for storing information. A second area 4 is also present on the record carrier 1, the second area e.g. comprising a chip. For more details on the record carrier 1 and its communication means with the device for reading and/or writing the record carrier 1 reference is again made to U.S. Pat. No. 6,044,046 A.

FIG. 2 shows a block diagram of a first embodiment of the reading and writing of data on an inventive record carrier. Left of the dotted line 20 one finds a record carrier 1 with the second area 4, which is also shown in an enlarged view below the record carrier 1. Between the dotted lines 20 and 21 the processes taking place in an inventive reading and writing device and the storage areas used thereby are shown, and right of the dotted line 21 one sees the data being supplied externally to an inventive system comprising a reading and writing device and a record carrier.

In the embodiment of FIG. 2 the first area 3 of the record carrier 1 stores the payload data in a form encrypted by a symmetric encryption method using a first cryptographic key called the asset key AK. This encrypted payload data are referred to in the figure as E_{AK}(data). The first area 3 furthermore stores as a first part of decryption information a third cryptographic key, called a hidden-channel key HCK. These items, i.e. the encrypted payload data E_{AK}(data) as well as the hidden-channel key HCK are read by the reading device e.g. via an optical channel by e.g. using a laser diode. In this way they are made available in the block 10 in the reading device.

In this implementation, the hidden-channel key HCK can be scrambled and/or encrypted in a secret way on the first area 3 within the payload data E_{AK}(data). I.e. the HCK can be encrypted and/or additionally scattered within the E_{AK}(data), this scattering e.g. being performed by flipping some bits of the E_{AK}(data). Then, a reading device not knowing this scrambling and/or encryption scheme, in the following just referred to as scrambling scheme for short, typically will ignore these few changed bits as reading errors. Thus, as long as the scrambling scheme is kept secret a user will not be able to obtain the hidden-channel key HCK explicitly. In this sense, the hidden-channel key HCK is read via a hidden channel between the first area 3 of the record carrier 1 and the reading device.

The second area 4 stores as a second part of decryption information a unique identifier, called the unique chip-in-disc identifier UCID, e.g. a serial number being unique among all inventive record carriers, and stores furthermore the asset key AK in a form encrypted by a symmetric encryption method using a second cryptographic key, called the chip-in-disc key CIDK. The such encrypted asset key is referred to as E_{CIDK}(AK). This symmetric encryption method may the same or may be a different one than the one used for the encryption of the payload data above. In that, the chip-in-disc key CIDK is chosen in a way that it is deducible from the joint usage of the first and second parts of decryption information, i.e. from the joint usage of the hidden-channel key HCK and the unique chip-in-disc identifier UCID.

The reading and decrypting of the data on record carrier 1 proceed as follows: The reading device reads e.g. via an optical channel the hidden-channel key HCK from the first area 3 into its internal block 1 0. Of course, if the hidden-channel key HCK is scrambled within the encrypted payload data E_{AK}(data), typically, part of these data will have to be read as well. Subsequently or simultaneously it further reads the unique chip-in-disc identifier UCID into the block 12 and the encrypted asset key E_{CDK}(AK) into the block 13. Typically these two latter read processes from the second area 4 use a different channel than the reading from the first area 3, e.g. if the second area 4 comprises a chip a radio frequency channel can be used.

Internally the reading device transfers the hidden-channel key HCK from block 10 into block 12, where both parts of decryption information, i.e. the hidden-channel key HCK as well as the unique chip-in-disc identifier UCID are used to compute the chip-in-disc key CIDK. E.g., as a concrete example, the chip-in-disc key CIDK might be computed via a one-way collision-resistant hash function H( . . . ) from the concatenation of the bit sequences of the unique chip-in-disc identifier UCID and the hidden-channel key HCK: CIDK=H(UCID 11 HCK). Using such a hash function offers the additional advantage of the chip-in-disc key CIDK requiring only a small storage area on the second area 4 of record carrier 1. But, of course, instead of a hash function H( . . . ), for deriving the chip-in-disc key CIDK, other methods may be used as well. Further examples are the usage of a symmetric encryption method employing the UCID as cryptographic key and the HCK as data to be encrypted or vice versa, i.e. computing: CIDK=E_{UCID}(HCK) or CIDK=E_{HCK}(UCID).

The chip-in-disc key CIDK is then internally transferred into the block 13, where it is used for decrypting the encrypted asset key E_{CIDK}(AK). Afterwards, the thus obtained asset key AK is internally transferred into the block 11. These processes typically will take place, together e.g. with reading some index and/or table of contents information on the record carrier 1, immediately after having inserted the record carrier 1 into the reading device.

Then, if encrypted payload data E_{AK}(data) is to be decrypted, e.g. if a song from an audio CD is to be played, the reading device will read said encrypted payload data E_{AK}(data) into its internal block 10, e.g. via an optical channel, and, typically, will continuously transfer it further into internal block 11. In block 11, the asset key AK is used for decrypting the encrypted payload data E_{AK}(data). The decrypted payload data can then be further processed in the reading device, e.g. a digitally stored song will be converted to analog and played via the loudspeakers, which is not shown in the figure.

FIG. 2 shows furthermore the processes taking place in receiving new content, i.e. new payload data, e.g. from the Internet and storing it on an inventive record carrier. In a block 15 being external to the system of record carrier 1 and the reading and/or writing device for it, e.g. in a block 15 residing on a server inside the Internet the new content is provided in a form E_{AK}(data) encrypted by a symmetric method using an asset key AK. Furthermore, block 15 also provides the hidden-channel key HCK and the asset key AK themselves. In order to prevent tapping the download of such new content the connection between external block 15 and a receiving block 16 inside the writing device for record carrier 1 might be provided via a secure authenticated channel.

In detail, the writing of new content on the record carrier 1 then takes place as follows: External block 15 transfers via a secure authenticated channel the new encrypted payload data E_{AK}(data), the hidden-channel key HCK, and the asset key AK to the writer-internal block 16. Block 16 writes the new encrypted payload data E_{AK}(data) and the hidden-channel key HCK, e.g. via an optical channel, on the first area 3 of the record carrier 1. As already mentioned, advantageously, on the first area 3, the hidden-channel key HCK is scrambled within the encrypted payload data E_{AK}(data). This scrambling might already be performed in the external block 15 or it might be performed in the writer-internal block 16. Furthermore, block 16 transfers the asset key AK to writer-internal block 17.

To conclude the writing process the asset key AK has to be encrypted and written to the second area 4. For that, at first the hidden-channel key HCK has to be transferred to the writer-internal block 10. This can be performed as in the reading process, i.e., after the hidden-channel key HCK has been written to the first area 3, block 10 can read it from the first area 3. Alternatively, if in block 16 the hidden-channel key HCK is known explicitly, block 16 can directly transfer it to block 10, which is indicated in FIG. 2 by a broken arrow. Afterwards, as in the reading process, block 10 transfers the hidden-channel key HCK to block 12, which reads the unique chip-in-disc identifier UCID from the second area 4, and computes from the HCK and UCID the chip-in-disc key CIDK. Block 12 then transfers the chip-in-disc key CIDK to block 17, which encrypts the asset key AK into E_{CIDK}(AK) by using a symmetric method employing the chip-in-disc key CIDK as cryptographic key. Finally, block 17 writes the encrypted asset key E_{CIDK}(AK), e.g. via an optical channel, on the second area 4 of record carrier 1.

Besides the encrypted payload data E_{AK}(data) and the asset key AK, the external block 15 might further provide additional information. An example for that are access rights. Access rights e.g. determine how often a song on an audio disc may be played. They can be written to the first area 3 and/or the second area 4 of the record carrier 1, and they can be administrated by the reading and/or writing device and/or by a built-in chip of the record carrier 1.

One skilled in the art will notice that distribution of decryption information disclosed in FIG. 2 implements a principle that may be summarized as “the secret coming from the disc and the uniqueness coming from the chip-in-disc”. I.e., the hidden-channel key HCK on the first area 3 represents the secret while the unique chip-in-disc identifier UCID represents the uniqueness, thus yielding via the one-way collision-resistant hash function H a secret and unique chip-in-disc key CIDK. But one skilled in the art will also notice that a reasonable level of protection is also reached with a non-unique chip-in-disc key CIDK. I.e., dropping the uniqueness restriction on the chip-in-disc identifier by replacing a unique UCID by a possibly non-unique chip-in-disc identifier and/or dropping the collision-resistance of the hash function H still improves the copy protection of an inventive record carrier as compared to the state of the art.

Such non-unique chip-in-disc identifiers may e.g. result from overlaps between different manufacturers, i.e. whereas each manufacturer may produce its record carriers with unique chip-in-disc identifiers UCID, e.g. by using a serial number, manufacturers may want to save the effort to negotiate disjoint ranges of chip-in-disc identifiers between them. The thus resulting very rare occasions of identical chip-in-disc identifiers will not much compromise the level of protection of inventive record carriers.

Concerning the hidden-channel keys HCK, especially if they are to be scrambled within the encrypted payload data E_{AK}(data), an advantageous choice is to generate one hidden-channel key HCK per title of record carrier. I.e., record carriers with the same title, i.e. those carrying the same payload share its hidden-channel keys HCK while record carriers with different titles also use different hidden-channel keys HCK.

Considering some possible attacks on the inventive copy-protection mechanism, one can make the following observations, where in all cases it is assumed that the unique chip-in-disc identifier UCID cannot be re-programmed by a user.

In trying to copy a first disc to a second one, a user may do a one-to-one copy of the first area 3, thereby copying the encrypted payload data E_{AK}(data) and the hidden-channel key HCK. After once having tapped the transmission of the encrypted asset key E_{CIDK1}(AK) of the first record carrier, this might e.g. be published on the Internet and a user disposing of the right equipment might write it on the second area 4 of the second record carrier. But the first and second record carriers will differ in their unique chip-in-disc identifiers UCID1 and UCID2 and thus in their chip-in-disc keys CIDK1 and CIDK2. Accordingly, the copied encrypted asset key E_{CIDK1}(AK) of the first record carrier cannot be decrypted with the chip-in-disc key CIDK2 of the second record carrier rendering the copy unreadable. Thus, even if a user is able to do a one-to-one copy of all re-programmable parts of an inventive record carrier, the non-reprogrammable unique chip-in-disc identifiers UCID1 and UCID2 prohibit this kind of attack.

Copying a disc to itself is of interest just in the case of diminishing access rights, e.g. in the case that a video DVD may only be played once or N times. Then, when starting to play such a disc the encrypted asset key E_{CIDK}(AK) may be tapped and later be re-written to the second area 4 of this record carrier. When buying new content e.g. by downloading from the Internet, alternatively, instead of tapping the encrypted asset key E_{CIDK}(AK) when starting to play such a disc, a user may tap this key while it is written to the second area 4 of the record carrier. Thus, this kind of attack cannot be prohibited by the inventive copy-protection method. But, of course, a user will need the right equipment for such re-programming, e.g. he will need to hack a legal player.

FIG. 3 shows a block diagram of a second embodiment of the reading and writing of data on an inventive record carrier. This second embodiment employs a counter mechanism for further increasing the level of protection as will be discussed below.

In large parts FIG. 3 corresponds to FIG. 2. Accordingly, blocks with identical functions have been given the same reference signs whereas blocks with similar functionality have been given the corresponding primed reference numeral. In the following, the description restricts to the differences to FIG. 2.

In FIG. 3, the second area 4 of the record carrier 1 comprises a chip 4′ storing the unique chip-in-disc identifier UCID, a first counter Cᵢ, and an encrypted version of the concatenation E_{CIDK}(AK∥Cₑ) of the asset key AK and a second counter Cₑ. As in FIG. 2, this encryption uses a symmetric method employing the chip-in-disc key CIDK as a cryptographic key. The chip 4′ allows the reading and/or writing device for the record carrier 1 only read access but no write access to the first counter Cᵢ. Therefore, this first counter Cᵢ is also called the internal counter Cᵢ. In the same way, as the chip 4′ grants read and write access to the second counter Cₑ this is also called the external counter Cₑ. A legal record carrier now is arranged in the way that the values of the internal counter Cᵢ and the external counter Cₑ are identical.

Reading of the record carrier 1 of FIG. 3 then works similarly to that of FIG. 2 with the following differences. In block 13′ corresponding to block 13 of FIG. 2 not only the asset key AK is decrypted but also the external counter Cₑ. More precisely, block 13′ first decrypts the concatenation “AK∥Cₑ” of the asset key AK and the external counter Cₑ, which is then separated into the asset key AK and the external counter Cₑ themselves. This separation can be made possible e.g. by employing external counters Cₑ of fixed length or by using a reserved separator for the concatenation of the asset AK and the external counter Cₑ. The asset key AK is, as in FIG. 2, transferred to the payload decryption block 11′ corresponding to block 11 of FIG. 2, but is also transferred to the encryption block 17′ corresponding to block 17 of FIG. 2. The external counter Cₑ is on the one hand given to the comparison block 18 and on the other hand to the encryption block 17′.

The comparison block 18 also reads the internal counter Cᵢ from the chip 4′ and then compares the external counter Cₑ with the internal counter Cᵢ. It transfers the result of this comparison to the payload decryption block 11′, which will now only then decrypt the payload data E_{AK}(data) if the external counter Cₑ coincided with the internal counter Cᵢ.

To complete the counter mechanism, after the external counter Cₑ and the internal counter Cᵢ have been read, the chip 4′ increments the internal counter Cᵢ by 1, the reading and/or writing device in block 17′ increments the external counter Cₑ by 1, encrypts the concatenation of the asset key AK with the just incremented external counter Cₑ using the chip-in-disc key CIDK, i.e. computes E_{CIDK}(AK∥Cₑ), and writes the result E_{CIDK}(AK∥Cₑ) back to the chip 4′. This cares for both the external counter Cₑ and the internal counter Cᵢ on the chip 4′ being incremented by 1 and, thus, coinciding again, and the record carrier 1 being ready for the next legal access.

One skilled in the art will notice that the counter mechanism is based on the facts that the internal counter Cᵢ cannot be influenced from outside the chip 4′ while the value of the external counter Cₑ is not known to a user because the hidden-channel key HCK is secret. Then, the incrementing of the two counters in safe environments together with the requirement of them keeping identical values creates a further increased level of protection as can be seen by re-visiting the attack of copying a disc to itself already discussed in connection with FIG. 2. Of course, as is assumed in all embodiments, the internal stores of the reading and/or writing device are assumed to be safe, too, which can e.g. be obtained by implementing them as one or several chips. Otherwise, an attacker would only need to tap the asset key AK inside the reading and/or writing device.

As already mentioned, the counter mechanism successfully blocks the copying of a disc to itself. This follows from the observation that restoring E_{CIDK}(AK∥Cₑ) to its initial value after having played the disc, i.e. restoring it to its value when starting to play the record carrier, also restores the external counter Cₑ to its initial value while the internal counter Cᵢ already has been incremented one or more times. Thus, the two counters will no more coincide and the reading and/or writing device will deny access to the record carrier.

As mentioned in the summary of the invention, these protection mechanisms can further be complemented by a revocation list of illegal record carriers, i.e. a revocation list can be used e.g. in addition to the above counter mechanism or also instead of it. On detection of an illegal record carrier the reading and/or writing device can execute, besides denying access to this record carrier, a counterfeit response routine ranging from a simple warning message to locking the device. For details, again reference is made to U.S. Pat. No. 6,028,936.

The previous embodiments shown in FIGS. 2 and 3 assumed that the hidden-channel key HCK is read in a safe way, i.e. via a hidden channel, by the reading device. This might e.g. be accomplished by scrambling the hidden-channel key HCK in a secret way within the encrypted payload data E_{AK}(data). Of course, if this hidden channel is compromised, e.g. if the scrambling scheme gets known, the whole copy-protection mechanism gets compromised. Therefore, as an alternative or as an additional safety mechanism the hidden-channel key HCK can be stored in encrypted form E_{DNK}(HCK) on the first area 3 of the record carrier 1.

FIG. 4 shows a block diagram of a corresponding third embodiment of the reading and writing of data on an inventive record carrier. Again, in large parts FIG. 4 corresponds to FIG. 2. Accordingly, blocks with identical functions have been given the same reference signs whereas blocks with similar functionality have been given the corresponding primed reference numeral. In the following, the description restricts to the differences to FIG. 2.

Instead of the hidden-channel key HCK itself the first area 3 of the record carrier 1 now stores it in encrypted form E_{DNK}(HCK), this encryption using a symmetric method employing as a cryptographic key a fourth cryptographic key denoted as the device-node key DNK. This device-node key DNK is stored within a new block 19 within the reading and/or writing device for the record carrier 1, and as such is a property of a legal such device. Accordingly, block 10′ of the reading and/or writing device, which corresponds to block 10 in FIG. 2, does not read the hidden-channel key HCK directly from the first area 3 but reads its encrypted version E_{DNK}(HCK). Proceeding further, block 19 transfers the device-node key DNK to block 10′, which now decrypts the encrypted E_{DNK}(HCK) in order to obtain the hidden-channel key HCK in the clear. The remaining reading process coincides with the one shown in FIG. 2.

In the same way, if storing an encrypted version E_{DNK}(HCK) of the hidden-channel key HCK, the writing of new content on a record carrier 1, as compared to FIG. 2, has to be modified accordingly, which is not shown in FIG. 4. Again, there are several possibilities. The encrypted E_{DNK}(HCK), possibly additionally scrambled within the encrypted payload data E_{AK}(data), can already be supplied by the external block 15 of FIG. 2. Alternatively, external block 15 may supply the hidden-channel key HCK in the clear to writer-internal block 16 of FIG. 2, which can then receive the device-node key DNK from block 19 to compute the encryption E_{DNK}(HCK) and, possibly, do the scrambling within the E_{AK}(data). Afterwards, as in FIG. 2, block 16 writes the encrypted payload data E_{AK}(data) as well as the encrypted form E_{DNK}(HCK) of the hidden-channel key HCK to the first area 3, and transfers the asset key AK to block 17.

To provide the hidden-channel key HCK to block 10′ for the writing process, as in FIG. 2, block 10′ can read its encrypted form E_{DNK}(HCK) from the first area 3 after block 16 has finished its writing, get DNK from block 19 and decrypt E_{DNK}(HCK) to HCK. Alternatively, as in FIG. 2, if block 16 explicitly disposes of the hidden-channel key HCK, it can directly transfer it to block 10′. The further writing proceeds as in FIG. 2, i.e., block 10′ gives the HCK to block 12. Block 12 reads the UCID from the second area 4, computes from the HCK and the UCID the CIDK and gives that to block 17. Block 17 encrypts the AK with the CIDK to E_{CIDK}(AK), and, finally writes the encrypted form E_{CIDK}(AK) of the asset key AK to the second area 4.

As is obvious to one skilled in the art the above embodiments can be modified in a variety of ways while still implementing the invention. E.g., the functionalities of the distinct blocks mentioned in the figures can be distributed in other ways or can be concentrated in a single or a few chips only. Therefore, above embodiments are not to be taken as limiting the extent of protection of this application.

1. A record carrier (1) having a first area (3) storing information (data), which is at least partly stored in encrypted form (E_{AK}(data)), this part being called an asset (E_{AK}(data)), and which includes a first part of decryption information (HCK, E_{DNK}(HCK)), and the record carrier (1) further having a second area (4) storing a second part of decryption information (UCID), wherein both the first (HCK) and second (UCID) parts of decryption information serve in decrypting the asset (E_{AK}(data)).

2. A record carrier (1) as claimed in claim 1,
characterized in that
the first (3) and second areas (4) comprise storage media of a different physical kind.

3. A record carrier (1) as claimed in claim 1,
characterized in that
the second area (4) comprises a chip (4′) for providing the store of the second area (4).

4. A record carrier (1) as claimed in claim 1,
characterized in that
a symmetric method using a first cryptographic key, called an asset key (AK), is used for asset en- and decryption, and in that
the asset key (AK) is stored in the second area (4) in an encrypted form, wherein for its encryption a symmetric encryption method has been used, this method employing a second cryptographic key (CIDK) in whose derivation both the first (HCK) and second (UCID) parts of decryption information have been used.

5. A record carrier (1) as claimed in claim 1,
characterized in that
a third cryptographic key, called a hidden-channel key (HCK), serves in the asset decryption, and in that
the hidden-channel key (HCK) is obtainable from the first part of decryption information (HCK, E_{DNK}(HCK)), in particular, that the hidden-channel key (HCK) coincides with the first part of decryption information (HCK) and that the first part of decryption information (HCK) is scrambled and/or encrypted within the information (data) stored in the first area (3).

6. A record carrier (1) as claimed in claim 3,
characterized in that
the chip (4′) is designed for storing a first counter (Cᵢ), and
the chip (4′) is designed for allowing an reading and/or writing device read access to the first counter (Cᵢ) but denying write access to it, and
the chip (4′) is designed for changing the value of the first counter (Cᵢ) each time the second part of decryption information (UCID) is read by an reading and/or writing device, and
the chip (4′) is designed for storing a second counter (Cₑ) in an encrypted form, wherein both the first (HCK) and second (UCID) parts of decryption information serve in decrypting the second counter (Cₑ).

7. A record carrier (1) as claimed in claim 3,
characterized in that
the chip (4′) is designed for checking the right of an reading and/or writing device to access the record carrier (1).

8. A record carrier (1) as claimed in claim 1,
characterized in that
the second area (4) is designed for storing user-specific settings serving in controlling the access of an reading and/or writing device to the record carrier (1) and/or in controlling the manner information being read from the record carrier (1) is presented by the reading and/or writing device to a user of the reading and/or writing device.

9. A device for reading from and/or writing to a record carrier (1) as claimed in claim 1, wherein the device is designed
for reading and/or writing the first part of decryption information (HCK, E_{DNK}(HCK)),
for reading and/or writing the second part of decryption information (UCID),
for reading and/or writing the asset (E_{AK}(data)),
optionally, for obtaining complete decryption information from both the first (HCK, E_{DNK}(HCK)) and second parts (UCID) of decryption information, and,
optionally, for decrypting and/or encrypting the asset (E_{AK}(data)) with the complete decryption information.

10. A device for reading and/or writing as claimed in claim 9,
characterized in that
the device is designed for accessing the first (3) and second areas (4) of the record carrier (1) in parallel.

11. A device for reading and/or writing as claimed in claim 9,
characterized in that
the device is designed for storing and maintaining a revocation list of identifiers (UCID), and in that
the device is designed for at least partly refusing a user of the device access to a record carrier (1) as claimed in claim 3 if the identifier (UCID) being stored on the record carrier (1) belongs to the revocation list.

12. A system for supporting copy protection, the system comprising a device as claimed in claim 9 and a record carrier (1) as claimed in claim 1.

13. A method for reading from and/or writing to a record carrier (1) as claimed in claim 1, with the steps:
reading and/or writing the first part of decryption information (HCK, E_{DNK}(HCK)),
reading and/or writing the second part of decryption information (UCID),
reading and/or writing the asset (E_{AK}(data)),
optionally, obtaining complete decryption information from both the first (HCK, E_{DNK}(HCK)) and second parts (UCID) of decryption information, and,
optionally, decrypting and/or encrypting the asset (E_{AK}(data)) with the complete decryption information.

14. A method for producing a record carrier (1) as claimed in claim 1, with the steps:
selecting an identifier (UCID), in particular, selecting an identifier (UCID) being different from the identifiers (UCID) having previously been selected in the method,
constructing the second part of decryption information (UCID) as comprising the identifier (UCID), and
producing the record carrier (1) with the thus constructed second part of decryption information (UCID) being stored on the second area (4) of the record carrier (1).
